(19) United States
(12) Patent Application Publication
(10) Pub. No.: US 2011/0171413 A1
(43) Pub. Date: Jul. 14, 2011

(54) CARBON NANOTUBE EMBEDDED TEXTILES

(76) Inventors: Farbod Alimohammadi, Tehran (IR); Mazeyar Parvinzadeh, Tehran (IR); Ali Shamei, Tehran (IR)

(21) Appl. No.: 13/052,059

(22) Filed: Mar. 19, 2011

(51) Int. Cl. B32B 9/00; B05D 1/18; D06B 19/00; B82Y 30/00

(52) U.S. Cl. 428/59; 427/180; 977/961

(57) ABSTRACT

Carbon nanotube embedded textiles and methods for production of carbon nanotube embedded textiles are disclosed. Initially, carbon nanotubes, a cationic surfactant, and distilled water are mixed to form a stabilized carbon nanotube mixture. A textile is then soaked in a solution of the stabilized carbon nanotube mixture and an electrolyte to form a carbon nanotube adsorbed textile. The carbon nanotube adsorbed textile is then dried. Next, the dried carbon nanotube adsorbed textile is treating in a solution of a crosslinking agent and a catalyst to form a carbon nanotube embedded textile. The carbon nanotube embedded textile is then dried.

### SPONSORSHIP STATEMENT

This application has been sponsored by the Iranian Nanotechnology Initiative Council, which does not have any rights in this application.

### TECHNICAL FIELD

This application generally relates to textile production, and more particularly relates to the production of carbon nanotube embedded textiles.

### BACKGROUND

Research on textiles having unique chemical, electrical, and thermal properties has increased in recent years. For example, conductive textiles can be produced by weaving metal strands into textile fibers and semiconducting textiles can be produced by impregnating fibers with carbon-based and/or metal-based powders. In particular, carbon nanotubes have been embedded in cotton fibers through layer-by-layer coating and catalytic cracking methods. However, current methods for embedding carbon nanotubes in textiles are not sufficient and, therefore, a need exists for a new method for production of carbon nanotube embedded textiles.

### SUMMARY

Carbon nanotube embedded textiles and methods for production of carbon nanotube embedded textiles are disclosed. Initially, carbon nanotubes, a cationic surfactant, and distilled water are mixed to form a stabilized carbon nanotube mixture. A textile is then soaked in a solution of the stabilized carbon nanotube mixture and an electrolyte to form a carbon nanotube adsorbed textile. The carbon nanotube adsorbed textile is then dried. Next, the dried carbon nanotube adsorbed textile is treated in a solution of a crosslinking agent and a catalyst to form a carbon nanotube embedded textile. The carbon nanotube embedded textile is then dried.

In some implementations, the carbon nanotubes can be multi-walled carbon nanotubes, the cationic surfactant can be cetyltrimethylammonium bromide, and the molar ratio of the carbon nanotubes to the cationic surfactant can range between 1:10 and 1:60. The stabilized carbon nanotube mixture can be sonicated until the mixture is stable and homogenous.

In some implementations, the textile can be cotton fabric and the electrolyte can be sodium chloride. The solution of the stabilized carbon nanotube mixture and the electrolyte can be heated.

In some implementations, the carbon nanotube adsorbed textile can be dried at room temperature and rinsed with distilled water. The crosslinking agent can be 1,2,3,4-butanetetracarboxylic acid, the catalyst can be sodium hypophosphite, and the molar ratio of the crosslinking agent to the catalyst can be 3:2. The carbon nanotube embedded textile can be cured at temperature between 120° C. and 180° C. and rinsed with distilled water.

Another method for production of carbon nanotube embedded textiles is also disclosed. Initially, multi-walled carbon nanotubes, cetyltrimethylammonium bromide, and distilled water can be mixed to form a stabilized carbon nanotube mixture. Next, the cotton fabric is soaked in a solution of the stabilized carbon nanotube mixture and sodium chloride to form a carbon nanotube adsorbed cotton. The carbon nanotube adsorbed cotton is then dried. The dried carbon nanotube adsorbed cotton is treated in a solution of 1,2,3,4-butanetetracarboxylic acid and sodium hypophosphite to form a carbon nanotube embedded cotton. Next, the carbon nanotube embedded cotton is cured.

In some implementations, the solution of the stabilized carbon nanotube mixture and the sodium chloride can be heated. The cured carbon nanotube adsorbed cotton can be rinsed with distilled water and then dried.

A carbon nanotube embedded textile is produced by a process including mixing carbon nanotubes, a cationic surfactant, and distilled water to form a stabilized carbon nanotube mixture, soaking a textile in a solution of the stabilized carbon nanotube mixture and an electrolyte to form a carbon nanotube adsorbed textile, drying the carbon nanotube adsorbed textile, treating the dried carbon nanotube adsorbed textile in a solution of a crosslinking agent and a catalyst to form a carbon nanotube embedded textile, and drying the carbon nanotube embedded textile.

Details of one or more implementations and/or embodiments of the production of carbon nanotube embedded textiles are set forth in the accompanying drawings and the description below. Other aspects that can be implemented will be apparent from the description and drawings, and from the claims.

### BRIEF DESCRIPTION OF DRAWINGS

FIG. 1 illustrates an example method for production of carbon nanotube embedded textiles.

FIG. 2 illustrates an example illustration of the crosslinking of cellulose fiber chains.

FIG. 3a illustrates a scanning electron microscopy image of raw cotton fibers.

FIG. 3b illustrates a scanning electron microscopy image of carbon nanotube embedded cotton fibers.

FIG. 4 illustrates a Raman spectrum of carbon nanotube embedded cotton.

FIG. 5 illustrates a graph of the weight loss of heated raw cotton and carbon nanotube embedded cotton over time.

FIG. 6 illustrates a graph of the weight loss of heated raw cotton and carbon nanotube embedded cotton at different temperatures.

FIG. 7 illustrates a graph of the reflectance of electromagnetic energy having a wavelength between 200 nm and 900 nm from raw cotton and carbon nanotube embedded cotton.

FIG. 8 illustrates a graph of the reflectance of electromagnetic energy having a wavelength between 950 nm and 1,500 nm from raw cotton and carbon nanotube embedded cotton.

Like reference symbols indicate like elements throughout the specification and drawings.

### DETAILED DESCRIPTION

Carbon nanotube embedded textiles, such as, for example, multi-walled carbon nanotube embedded cotton fabric, and methods of producing carbon nanotube embedded textiles are disclosed. As explained in greater detail below, the carbon nanotube embedded textiles are more antibacterial, conductive, crease resistant, flame retardant, thermally stable, and electromagnetic energy absorbent than raw textiles.

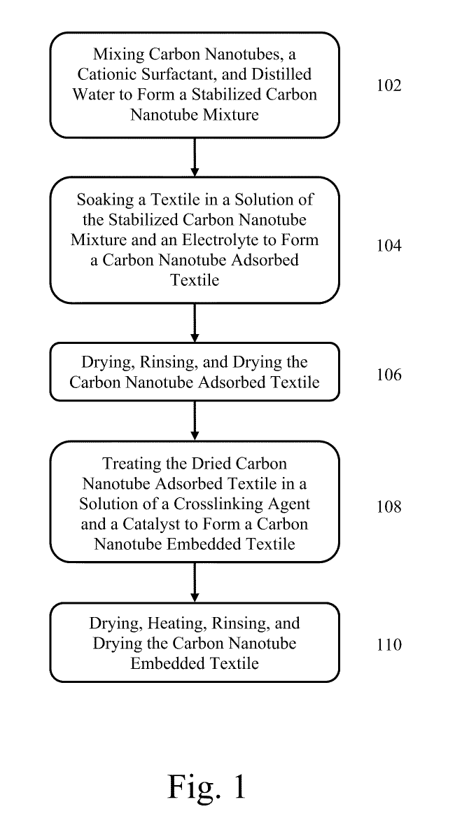

Referring to FIG. 1, a method for production of carbon nanotube (“CNT”) embedded textiles is illustrated. Initially, CNTs, a cationic surfactant, and distilled water are mixed to form a stabilized CNT mixture (step 102). The CNTs can be, for example, single-walled CNTs (hereinafter “SWCNTs”), multi-walled CNTs (hereinafter “MWCNTs”), and/or modified CNTs. MWCNTs can have an outer diameter of 10 to 40 nm, a length of 1 to 10 μm, and a Brunauer, Emmett and Teller (“BET”) specific surface area of about 270 m²/gr. The smaller the diameter and/or the length of the MWCNTs, the better their adsorption into the textile fibers.

Because pristine CNTs are hydrophobic and prone to aggregate and deposit in aqueous media due to the high van der Waals interactions along the length of the CNTs, a surfactant can be used to uniformly and stably disperse the CNTs in a solution. The surfactant can also act as a leveling agent. The surfactant can be, for example, cetyltrimethylammonium bromide (“CTAB”), sodium dodecyl sulfate (“SDS”), polyethylene oxide (“PEO”), polyoxyethylene sorbitan monolaurate (“Tween”), octyl phenol ethoxylate (“Triton X-100”), and/or polymers, such as polyvinylpyrrolidone (“PVP”) and polyvinyl alcohol (“PVA”).

In some implementations, MWCNTs can be mixed with the cationic surfactant at a molar ratio ranging from 1:10 to 1:60 in distilled water. By changing the molar ratio, the concentration of MWCNTs ultimately embedded in the textile will also change. The mixture of the MWCNTs, cationic surfactant, and distilled water is then sonicated by ultrasonic radiation for about two hours to produce a stable and homogenous dispersion. Whereas untreated MWCNTs have an average zeta potential of −32.6 mV, the stabilized MWCNTs have an average zeta potential of 46.3 mV, thereby proving the increased stability of the MWCNTs against aggregation. Following sonication, a stabilized CNT mixture is formed.

Next, a textile is soaked in a solution of the stabilized CNT mixture and an electrolyte to form a CNT adsorbed textile (step 104). The textile can be made from any material, such as, for example, wool, silk, cotton, flax, jute, nylon, polyester, and/or acrylic sources. The electrolyte can be any electrically conductive substance containing free ions, such as, for example, sodium chloride (NaCl) and/or sodium sulphate (Na₂SO₄).

In some implementations, the textile is initially soaked in a solution including the stabilized CNT mixture. The solution is then gradually heated for about ten minutes until it reaches its boiling temperature. The electrolyte is then gradually added to the solution to promote adsorption of the stabilized CNT mixture in the textile. The sodium chloride neutralizes the negative charge of the, for example, wet cotton fibers which would otherwise act to repel the anionic MWCNTs in the stabilized CNT mixture and, thereby, improves the penetration, uniformity, adsorption, exhaustion, and levelling of the MWCNTs into the cellulose fibers. The exhaustion and uniformity of the adsorption of the CNTs in the textile partly depends on the amount of electrolyte added to the solution and the temperature of the solution. Moreover, the diffusion of the CNTs is improved due to the swelling of the cellulose fibers in the heated aqueous solution including the stabilized CNT mixture.

The amount of electrolyte added to the solution can range from 20% to 300% of the weights of the CNTs. If too much of the electrolyte is added to the solution, the MWCNTs will aggregate in the solution and the adsorption of MWCNTs into the textile fibers will thereby be reduced. The textile is soaked in the solution of the stabilized CNT mixture and the electrolyte for about 20 to 60 minutes to form a CNT adsorbed textile. In some implementations, other additives, such as a catalyst, can also be added to the solution of the stabilized CNT mixture and the electrolyte.

The CNT adsorbed textile is then removed from the solution, dried, rinsed, and again dried (step 106). The CNT adsorbed textile can be dried at room temperature of about 20° C. to 25° C. In some implementations, the CNT adsorbed textile can be dried in a heated environment at a temperature greater than 25° C. to reduce the drying time. The dried CNT adsorbed textile can then be rinsed with distilled water for 1 to 10 minutes to remove any excess cationic surfactant and electrolyte. Following rinsing, the CNT adsorbed textile can be dried again at room temperature or in a heated environment.

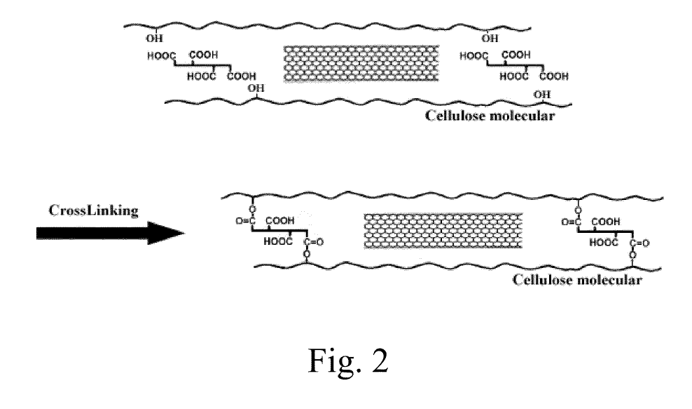

Next, the dried CNT adsorbed textile is treated in a solution of a crosslinking agent and a catalyst and is then padded to a wet pick-up ranging from 30% to 300% to form a CNT embedded textile (step 108). The crosslinking agent can be, for example, 1,2,3,4-butanetetracarboxylic acid (“BTCA”), citric acid (C₆H₈O₇), maleic acid (C₄H₄O₄), succinic acid (C₄H₆O₄), benzene hexacarboxylic acid (C₁₂H₆O₁₂), and/or various polycarboxylic acids. BTCA is an environmentally friendly, formaldehyde-free carboxylic acid that can improve the crease resistance of textiles. The application of the crosslinkling agent also improves the fastness of the CNTs in the textile to abrasion and washing by creating a network between the cellulose fiber chains, as illustrated in FIG. 2.

The catalyst can be an alkali metal salt of a phosphorus-containing acid and, preferably, a hypophosphite. The catalyst can be, for example, sodium hypophosphite (“SHP”) or sodium carbonate (Na₂CO₃). In some implementations, the crosslinking agent and the catalyst can be mixed at a molar ratio of 3:2.

Then, the CNT embedded textile is dried, heated, rinsed, and again dried (step 110). The CNT embedded textile can be initially dried at, for example, 60° C. for about three minutes. Then, the CNT embedded textile is cured at 120° C. to 180° C. for about four minutes. The cured CNT embedded textile can then be rinsed with distilled water for about 10 minutes to remove any excess crosslinking agent and catalyst. Following rinsing, the CNT embedded textile can be fully dried at room temperature or in a heated environment.

Carbon Nanotube Embedded Cotton Example

In some implementations, to produce CNT embedded cotton, 0.09 grams of MWCNTs are mixed with 3.6 grams of the cationic surfactant CTAB, resulting in a molar ratio of 1:40, in 900 cubic centimeters of distilled water to form a stabilized CNT mixture (step 102). The stabilized CNT mixture is stirred for about two hours at a temperature of 40° C. Cotton fabric is then soaked in the stabilized CNT mixture and the temperature of the mixture is increased at a rate of 5° C. per minute until it reaches its boiling temperature of 95° C. Next, 7.20 cubic centimeters of sodium chloride solution having a concentration of 200 gr/L is gradually added to the stabilized CNT mixture to form CNT adsorbed cotton (step 104). The CNT adsorbed cotton is then dried at room temperature for 35 minutes, rinsed with distilled water for 5 minutes, and again dried at room temperature (step 106). The dried CNT adsorbed cotton is treated with a solution of BTCA and SHP and padded to a wet pick-up of 200% to form CNT embedded cotton (step 108). The CNT embedded cotton is then dried at 60° C. for about three minutes, cured at 180° C. for about four minutes, and then rinsed with distilled water for about 10 minutes to remove any excess crosslinking agent and catalyst. Following rinsing, the CNT embedded textile is fully dried at room temperature (step 110).

Surface Morphology

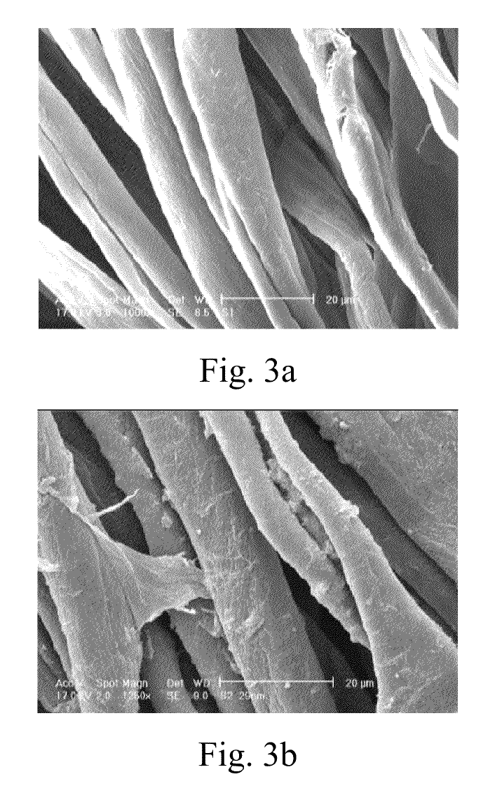

FIG. 3a shows a scanning electron microscopy (“SEM”) image of raw cotton fibers at a magnification of 1,000 times and FIG. 3b shows an SEM image of CNT embedded cotton prepared according to the EXAMPLE described above at a magnification of 1,250 times. MWCNTs can be seen on the surface of the cotton fibers in FIG. 3b, whereas the MWCNTs are not present in FIG. 3a.

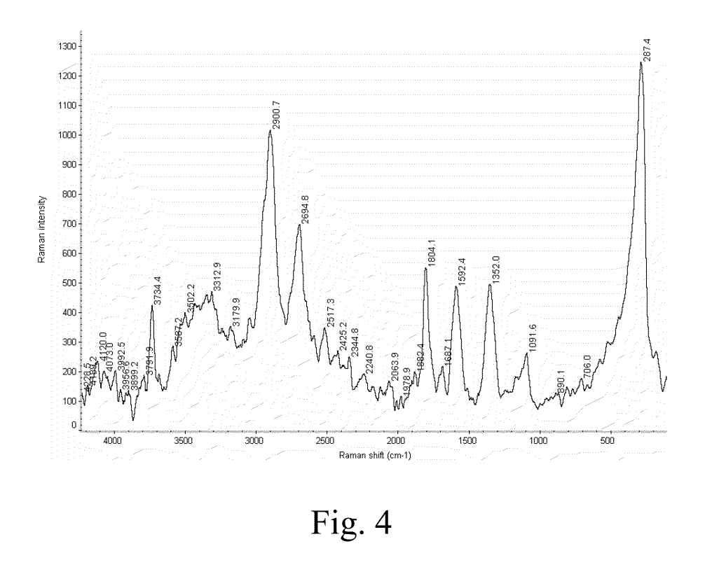

FIG. 4 shows a Raman spectrum of the CNT embedded cotton. The peaks at 1352 cm⁻¹ and 1592 cm⁻¹ in FIG. 4 occur due to the applicantion of the MWCNTs. In particular, the peak at 1352.0 cm⁻¹ (D-Band) is because of the irregularity and the structural deficiency of the MWCNTs and the peak at 1592.4 cm⁻¹ (G-Band) is because of the graphite bonds of the MWCNTs. The peak at 1687.1 cm⁻¹ is because of the BTCA.

Antibacterial Properties

The effect of CNTs on bacteria has not been widely studied. CNTs must be in direct contact with microorganisms, biomolecules, and/or macromolecules, such as viruses, bacteria, and toxins, to absorb them and/or destroy or deform their membranes. The antibacterial properties of the CNT embedded cotton prepared according to the EXAMPLE described above were analysed.

Initially, Escherichia coli and staphylococcus bacteria were suspended in different test tubes containing saline solution at a concentration of 0.5 McFarland. The test tubes were then incubated at about 37° C. and agitated at 220 RPM for 2 hours. Then, serial dilution was performed in five steps at a dilution of 1:100000, resulting in a concentration of about 1.5×10³ CFU/mL for antibacterial testing.

Then, one cubic centimeter of the bacterial suspension and two cubic centimeters of Tryptic Soy Broth were added to separate test tubes containing a piece of the CNT embedded cotton. Following measurement, it was found that 99.9% of the Escherichia coli and staphylococcus bacteria were killed by the CNT embedded cotton. As such, the CNT embedded cotton has high antibacterial properties.

Electrical Resistance and Rinsing Stability

The rinsing stability of the CNT embedded cotton prepared according to the EXAMPLE described above was measured by rinsing the CNT embedded cotton in a solution of non-ionic detergent with a concentration of 2 g/L at 50° C. for 45 min at 42 RPM according to the AATCC 61(2A)-1996 method. To measure the electrical resistance of the CNT embedded textiles having various CNT concentrations, two 40 mm electrodes spaced 30 mm apart from one another were placed on each of the CNT embedded textiles. The electrical resistance between the two electrodes was measured using an ohmmeter. Because CNTs are conductive, the greater the measured resistance of the CNT embedded cotton, the lower the concentration of CNTs adsorbed in the textile.

The measured electrical resistance and rinsing stability after washing the CNT embedded cotton having CNT concentrations of 100, 250, 500, 1000, and 1500 ppm are shown in TABLE 1.

TABLE 1

| | Surface | Surface | Surface |
|---|---|---|---|
| CNT | Resistance | Resistance | Resistance |
| Concentration | before | After a Single | After Two |
| (PPM) | Rinsing (Ω) | Rinsing (Ω) | Rinsings (Ω) |
| 100 | 20.15 MΩ | 21.18 MΩ | 23.96 MΩ |
| 250 | 17.80 KΩ | 21.60 KΩ | 21.83 KΩ |
| 500 | 3.147 KΩ | 3.260 KΩ | 3.360 KΩ |
| 1000 | 2.092 KΩ | 2.450 KΩ | 2.580 KΩ |
| 1500 | 1.202 KΩ | 1.293 KΩ | 1.550 KΩ |

As shown in TABLE 1, the electronic resistance after one or two rinsings of the CNT embedded textiles increases only slightly, indicating a high rinsing stability of the textiles. The change in electrical resistance after one or two rinsings is smaller as the concentration of CNTs is increased, indicating that a higher concentration of CNTs improves rinsing stability.

Crease Resistance Properties

The crease resistance of the CNT embedded cotton prepared according to the EXAMPLE described above was measured by the AATCC 66-2003 method. In this method, the CNT embedded cotton pieces are folded under a compression force for about five minutes and the recovery angle is then measured. Seven textile samples were prepared: raw cotton sample, a cotton sample treated with a solution including the crosslinking agent and the catalyst SHP, and CNT embedded cotton with CNT concentrations of 100, 250, 500, 1000, and 1500 ppm. The recovery angle of each textile sample is shown in TABLE 2.

TABLE 2

| Sample | Recovery Angle (Θ) |
|---|---|
| Raw Cotton | 109.9° |
| Crosslinked Cotton | 140.4° |
| CNT Embedded Cotton (100 ppm) | 93.4° |
| CNT Embedded Cotton (250 ppm) | 118.2° |
| CNT Embedded Cotton (500 ppm) | 124.8° |
| CNT Embedded Cotton (1000 ppm) | 129.2° |
| CNT Embedded Cotton (1500 ppm) | 145.6° |

As shown in TABLE 2, the crosslinked cotton has better crease resistant properties than CNT embedded cotton at CNT concentrations lower than 1500 ppm. However, above a CNT concentration of 250 ppm, the crease resistant properties of the CNT embedded cotton are better than raw cotton.

Flammability Properties

The flammability properties of the CNT embedded cotton prepared according to the EXAMPLE described above was determined by measuring the limiting oxygen index. The limiting oxygen index is the minimum concentration of oxygen that will support combustion and is measured by passing a mixture of oxygen and nitrogen over burning CNT embedded textile, and reducing the oxygen level until the minimum oxygen level that supports the burning is reached. The limiting oxygen indices for raw cotton and CNT embedded cotton with CNT concentrations of 100, 250, 500, 1000, and 1500 ppm are shown in TABLE 3.

TABLE 3

| | | CNT | CNT | CNT | CNT | CNT |
|---|---|---|---|---|---|---|
| | | Em- | Em- | Em- | Em- | Em- |
| | | bedded | bedded | bedded | bedded | bedded |
| | | Cotton | Cotton | Cotton | Cotton | Cotton |
| | Raw | (100 | (250 | (500 | (1000 | (1500 |
| Sample | Cotton | ppm) | ppm) | ppm) | ppm) | ppm) |
| Limiting | 17.6% | 22.2% | 23.1% | 23.2% | 23.7% | 23.8% |
| Oxygen | | | | | | |
| Index | | | | | | |
| (%) | | | | | | |

As shown in TABLE 3, the amount of oxygen necessary to support combustion increases as the concentration of CNTs is increased in the cotton fabric. As such, the flammability of the CNT embedded textile is lower than raw cotton. In addition, above CNT concentrations of 250 ppm, the difference in flammability is minor.

Thermogravimetric Properties

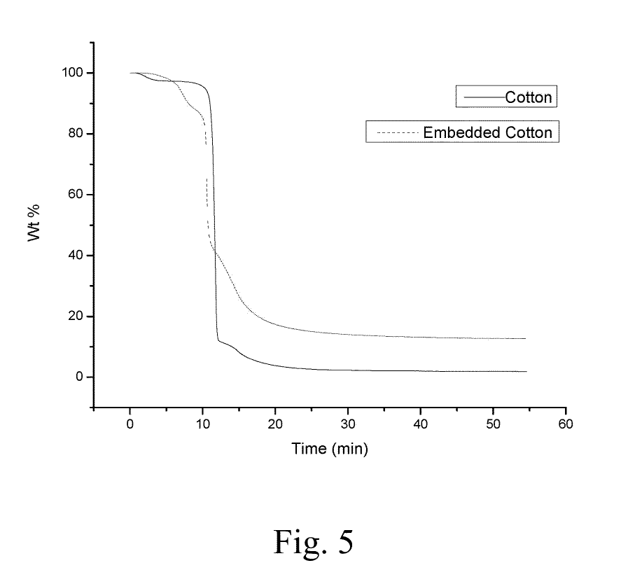

Thermogravimetric tests on the CNT embedded cotton prepared according to the EXAMPLE described above were performed by two methods. In the first method, the temperature of raw cotton and CNT embedded cotton was increased to 450° C., and then kept constant at atmospheric pressure. Referring to FIG. 5, the time following when the raw cotton and the CNT embedded cotton reached 450° C. and the change is weight of the textiles is illustrated. As shown in FIG. 5, the change in weight of the two samples before 10 minutes is minimal. After 10 minutes, the change in the weight of the CNT embedded cotton is less than that of the raw cotton.

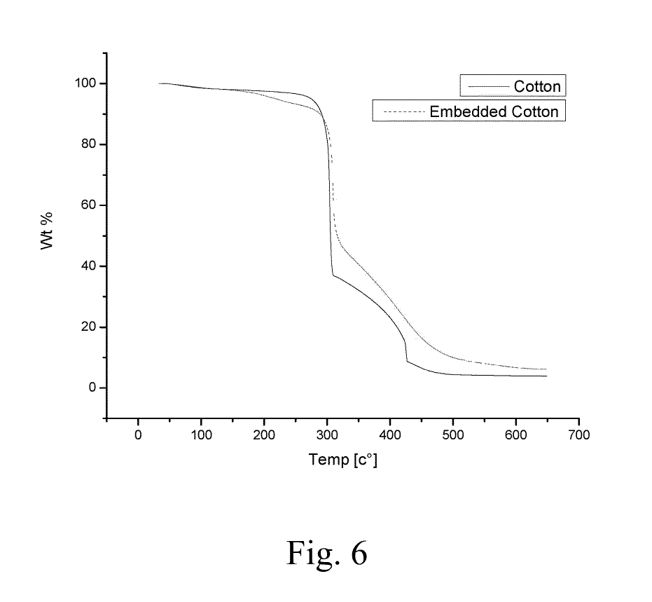

In the second method, the temperature of raw cotton and CNT embedded cotton was increased to 650° C. at 10° C./min and at atmospheric pressure. Referring to FIG. 6, the temperature of the raw cotton and the CNT embedded cotton and the change in weight of the textiles are illustrated. As shown in FIG. 6, the change in weight of the two samples significantly changes at temperature greater than 300° C. However, the change in the weight of the CNT embedded cotton is less than that of the raw cotton above 300° C.

Electromagnetic Energy Reflection Properties

The electromagnetic energy reflection properties of raw cotton and CNT embedded cotton prepared according to the EXAMPLE described above were measured. The electromagnetic energy can be electromagnetic energy at any wavelength, such as radio waves, visible light, infrared light, ultraviolet light, radar, microwaves, x-rays, and/or gamma-rays. To test reflectance, electromagnetic energy was applied to raw cotton and the CNT embedded cotton and the energy reflected from the samples was measured.

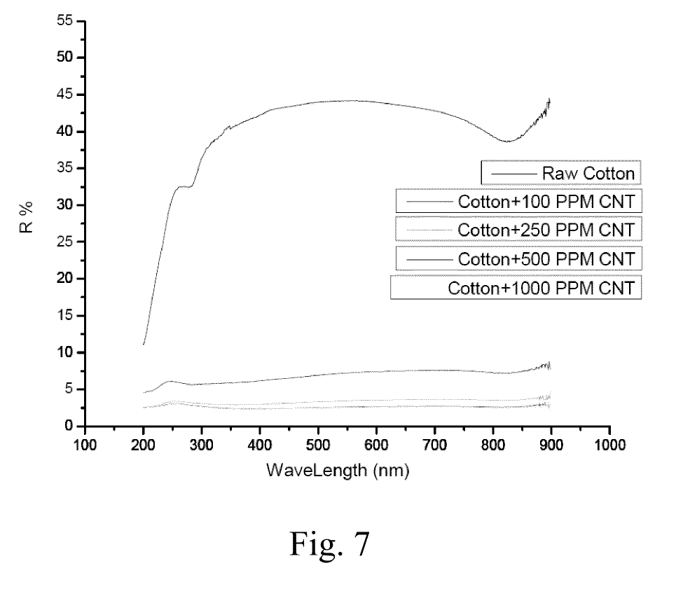

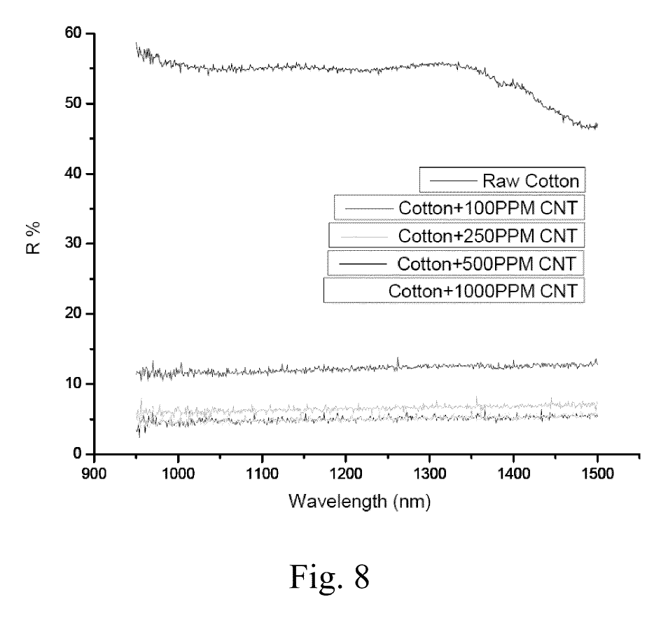

FIG. 7 illustrates the reflectance of electromagnetic energy having a wavelength between 200 nm and 900 nm and FIG. 8 illustrates the reflectance of electromagnetic energy having a wavelength between 950 nm and 1,500 nm. As shown in FIGS. 7 and 8, the reflectance of CNT embedded cotton at various CNT concentrations is significantly lower than the reflectance of raw cotton. However, as the concentration of CNTs embedded in the cotton is increased above 100 ppm, the reflectance is decreased.

It is to be understood the implementations are not limited to the particular processes, devices, and/or apparatus described which may, of course, vary. It is also to be understood that the terminology used herein is for the purpose of describing particular embodiments only, and is not intended to be limiting. As used in this application, the singular forms “a,” “an,” and “the” include plural referents unless the content clearly indicates otherwise.

Reference in the specification to “one implementation” or “an implementation” means that a particular feature, structure, characteristic, or function described in connection with the implementation is included in at least one implementation herein. The appearances of the phrase “in some implementations” in the specification do not necessarily all refer to the same implementation.

Accordingly, other embodiments and/or implementations are within the scope of this application.

What is claimed is:

1. A method for production of carbon nanotube embedded textiles, comprising:
mixing carbon nanotubes, a cationic surfactant, and distilled water to form a stabilized carbon nanotube mixture;
soaking a textile in a solution of the stabilized carbon nanotube mixture and an electrolyte to form a carbon nanotube adsorbed textile;
drying the carbon nanotube adsorbed textile;
treating the dried carbon nanotube adsorbed textile in a solution of a crosslinking agent and a catalyst to form a carbon nanotube embedded textile; and
drying the carbon nanotube embedded textile.

2. The method of claim 1, wherein mixing the carbon nanotubes, the cationic surfactant, and the distilled water to form the stabilized carbon nanotube mixture comprises mixing multi-walled carbon nanotubes, the cationic surfactant, and the distilled water to form the stabilized carbon nanotube mixture.

3. The method of claim 1, wherein mixing the carbon nanotubes, the cationic surfactant, and the distilled water to form the stabilized carbon nanotube mixture comprises mixing the carbon nanotubes, cetyltrimethylammonium bromide, and the distilled water to form the stabilized carbon nanotube mixture.

4. The method of claim 1, wherein the molar ratio of the carbon nanotubes to the cationic surfactant can range between 1:10 and 1:60.

5. The method of claim 1, further comprising sonicating the stabilized carbon nanotube mixture until the mixture is stable and homogenous.

6. The method of claim 1, wherein soaking the textile in the solution of the stabilized carbon nanotube mixture and the electrolyte to form the carbon nanotube adsorbed textile comprises soaking cotton fabric in the solution of the stabilized carbon nanotube mixture and the electrolyte to form carbon nanotube adsorbed cotton.

7. The method of claim 1, wherein soaking the textile in the solution of the stabilized carbon nanotube mixture and the electrolyte to form the carbon nanotube adsorbed textile comprises soaking the textile in the solution of the stabilized carbon nanotube mixture and sodium chloride to form the carbon nanotube adsorbed textile.

8. The method of claim 1, wherein soaking the textile in the solution of the stabilized carbon nanotube mixture and the electrolyte to form the carbon nanotube adsorbed textile comprises heating the solution of the stabilized carbon nanotube mixture and the electrolyte.

9. The method of claim 1, wherein drying the carbon nanotube adsorbed textile comprises drying the carbon nanotube adsorbed textile at room temperature.

10. The method of claim 1, further comprising rinsing the carbon nanotube adsorbed textile with distilled water.

11. The method of claim 1, wherein treating the dried carbon nanotube adsorbed textile in the solution of the crosslinking agent and the catalyst to form the carbon nanotube embedded textile comprises treating the dried carbon nanotube adsorbed textile in a solution of 1,2,3,4-butanetetracarboxylic acid and the catalyst to form the carbon nanotube embedded textile.

12. The method of claim 11, wherein treating the dried carbon nanotube adsorbed textile in the solution of the crosslinking agent and the catalyst to form the carbon nanotube embedded textile comprises treating the dried carbon nanotube adsorbed textile in a solution of the 1,2,3,4-butanetetracarboxylic acid and sodium hypophosphite to form the carbon nanotube embedded textile.

13. The method of claim 1, wherein the molar ratio of the crosslinking agent to the catalyst is 3:2.

14. The method of claim 1, wherein drying the carbon nanotube embedded textile comprises curing the carbon nanotube embedded textile at a temperature between 120° C. and 180° C.

15. The method of claim 1, further comprising rinsing the carbon nanotube embedded textile with distilled water.

16. A method for production of carbon nanotube embedded textiles, comprising:
mixing multi-walled carbon nanotubes, cetyltrimethylammonium bromide, and distilled water to form a stabilized carbon nanotube mixture;
soaking cotton fabric in a solution of the stabilized carbon nanotube mixture and sodium chloride to form carbon nanotube adsorbed cotton;
drying the carbon nanotube adsorbed cotton;
treating the dried carbon nanotube adsorbed cotton in a solution of 1,2,3,4-butanetetracarboxylic acid and sodium hypophosphite to form carbon nanotube embedded cotton; and
curing the carbon nanotube embedded cotton.

17. The method of claim 16, wherein soaking the cotton fabric in the solution of the stabilized carbon nanotube mixture and the sodium chloride to form the carbon nanotube adsorbed cotton comprises heating the solution of the stabilized carbon nanotube mixture and the sodium chloride.

18. The method of claim 16, further comprising rinsing the cured carbon nanotube embedded cotton with distilled water.

19. The method of claim 18, further comprising drying the cured carbon nanotube embedded cotton.

20. A carbon nanotube embedded textile produced by a process comprising the steps of:
mixing carbon nanotubes, a surfactant, and distilled water to form a stabilized carbon nanotube mixture;
soaking a textile in a solution of the stabilized carbon nanotube mixture and an electrolyte to form a carbon nanotube adsorbed textile;
drying the carbon nanotube adsorbed textile;
treating the dried carbon nanotube adsorbed textile in a solution of a crosslinking agent and a catalyst to form a carbon nanotube embedded textile; and
drying the carbon nanotube embedded textile.
